(19) United States
(12) Patent Application Publication
(10) Pub. No.: US 2022/0314298 A1
(43) Pub. Date: Oct. 6, 2022

(54) TRANSFER METHOD, MANIPULATION SYSTEM DESIGNED THEREFOR, AND BENDING INSTALLATION

(71) Applicant: TRUMPF Maschinen Austria GmbH & Co. KG., Pasching (AT)

(72) Inventors: Michael AUZINGER, Linz (AT); Thomas DENKMEIER, Traun (AT); Andreas FLOHR, Linz (AT); Gerhard GUGLER, Niederranna (AT); Herbert POESCHKO, Leonding (AT)

(73) Assignee: TRUMPF Maschinen Austria GmbH & Co. KG., Pasching (AT)

(21) Appl. No.: 17/627,206

(22) PCT Filed: Jul. 30, 2020
(86) PCT No.: PCT/AT2020/060283

§ 371 Date: Jan. 14, 2022

(30) Foreign Application Priority Data
Aug. 1, 2019 (AT) A50694/2019

(51) Int. Cl. B21D 43/24; B25J 9/00; B21D 5/02

(52) U.S. Cl. CPC B21D 43/24; B25J 9/0084; B21D 5/0281

(57) ABSTRACT

A method for transferring a workpiece from a first manipulator to a second manipulator by means of a manipulation system in a bending installation having at least one bending machine is provided. Each manipulator comprises first, second, and third manipulator arms, each of which is pivotable about second axes, third axes, and fourth axes and exclusively in a parallel orientation with respect to a first axis of a guide arrangement. The workpiece is grasped by a holding arrangement of the first manipulator. The third manipulator arms are oriented to be opposite and to project towards one another, and the same workpiece is grasped by a holding arrangement of the second manipulator and subsequently released from the holding arrangement of the first manipulator for the direct transfer process. The invention furthermore relates to a manipulation system and a bending installation equipped therewith.

### CROSS REFERENCE TO RELATED APPLICATIONS

This application is the National Stage of PCT/AT2020/060283 filed on Jul. 30, 2020, which claims priority under 35 U.S.C. § 119 of Austrian Application No. A50694/2019 filed on Aug. 1, 2019, the disclosure of which is incorporated by reference. The international application under PCT article 21(2) was not published in English.

The invention relates to a transfer method for directly transferring at least one sheet metal to be bent or one workpiece formed from a sheet metal from a first manipulator to at least one second manipulator by means of a manipulation system in a bending installation having at least one bending machine, a manipulation system designed therefor, as well as a bending installation with such a manipulation system.

EP 0 914 879 A1 describes a method and a bending installation for the automatic bending of sheet metal material. For this purpose, a first manipulator and a second manipulator are provided, which are displaceable independently of one another on a common guide arrangement, wherein the common guide arrangement is in parallel orientation with respect to the longitudinal extension of the bending region of the bending press. Each of the manipulators has a base body arranged so as to be displaceable on the guide arrangement and, situated thereon, an articulated arm having multiple arm parts. On each end of each articulated arm facing away from the base body, a gripper element is arranged, which is rotatable about two axes that are orthogonal relative to one another. The individual arm parts are each rotatable about horizontal rotational axes oriented in parallel orientation with respect to the longitudinal extension of the guide arrangement. The sheet metal to be bent is collected in a loading zone by the first manipulator, and a first set of bending operations is performed on the first sheet metal during a first working step of the bending cycle. In this process, the first sheet metal is held and moved by the first manipulator under controlled conditions, wherein the second manipulator is held on standby. At the end of the first set of bending operations, the partially bent first sheet metal is held clamped between shaping elements of the bending press and released by the first manipulator. Then, the first sheet metal that is held to be clamped is collected by the second manipulator while the same first sheet metal is fixedly held between the shaping elements of the bending press. Subsequently, a second set of bending operations is performed by means of the second manipulator manipulating the first sheet metal. After completion of the second set of bending operations, the first sheet metal is placed down and released in a delivery zone by the second manipulator. During the performance of the second set of bending operations, the first manipulator can collect a second sheet metal from the loading zone.

WO 2013/185834 A1 describes a multiple arrangement of gripping robots in which multi-joints are always provided. In the exemplary embodiment according to FIG. 6, two receiving robots for receiving blanks and forwarding them to further robots are provided instead of the linear conveyor. Each of the receiving robots can move from a central, common receiving position, at which it receives a blank output by the blanking shear or blanking press, to a lateral conveying position. The two receiving robots themselves are arranged base-side, and the further robots are situated in a suspended position. The blank to be further transported by the first receiving robot can only be accepted by one of the further robots or by both of them together. The same applies to the transport of the blank from the second receiving robot to the further robots. The first further robots are situated on a first side of the stack system, and the second further robots are situated on the other side of the stack system. Upon transfer, the receiving robots hold the blanks on the bottom side, the further robots do so on the upper side in each case. Moreover, the gripping robots may be mounted overhead so as to be stationary in the roof or ceiling region. Moreover, the gripping robots may be fixedly mounted overhead in the roof or ceiling region. In an operating mode, at least two robots may grip simultaneously on one and the same workpiece.

DE 38 17 117 A1 describes a device for handling workpieces in a press line by means of at least two independent handling robots working separately and in opposing directions to one another. While the one robot retrieves the workpiece from the one processing station and transports it in the neighboring station, the other robot already returns empty. Simultaneously, the device allows to minimize the distances and the traveling speed. The two robots are separately controllable but adapted to one another in their motion sequence to avoid collisions. The handling arms of the robots are additionally mounted on the base body so as to be rotatable about a base axis rising up vertically. A direct transfer of workpieces from one of the robots to the other robot is not provided.

EP 2 195 267 B2 describes a method for unstacking plate-shaped parts, in particular sheet metal blanks, by means of a pair of robots which are displaceable in a suspended manner along a linear guide device in the ceiling region and which are independent of one another. Each of the robots is guided with its robot base on the linear guide device, wherein one motion unit having multiple arms thereon is arranged on each robot base. The entire motion unit is mounted on the robot base so as to be rotatable about a separate vertical axis. Due to the coordinated pivoting motions and optionally possible linear displacements, a continuous transfer process from a stack of parts to a delivery point is achieved.

US 2018/071806 A1 describes a production plant with multiple workstations as well as stationarily arranged robots located between them for further transport of the workpieces to be processed. The individual robots are not intended for direct cooperation with one another and the simultaneous grasping of workpieces.

From EP 2 875 878 A1, a manufacturing process has become known, in which two processing steps running independently and simultaneously are carried out in an automated manner and without any manual intervention. The individual robots each have a multi-axis arrangement. For each of the manufacturing lines, separate robots are provided. A simultaneous and opposite gripping of a workpiece by two cooperating robots cannot be gathered.

With the manipulators used up to now, having four axes extending in parallel to one another and a fifth handling axis extending in a perpendicular orientation relative thereto, a direct transfer between two manipulators located next to each other has not been possible without the step of intermediate storing of the sheet metal or workpiece to be transferred.

The object of the present invention was to overcome the disadvantages of the prior art and to provide a transfer method, a manipulation system, and a bending installation comprising such a manipulation system, by means of which an even quicker and safer transfer process between two cooperating manipulators can be carried out.

This object is achieved by a method for transferring, a manipulation system, and a bending installation comprising such a manipulation system, according to the claims.

An object of the invention is achieved by the transfer method, in which a direct transfer of at least one sheet metal to be bent or one workpiece formed from a sheet metal in a bending installation having at least one bending machine takes place by means of a manipulation system, from a first manipulator to at least one second manipulator, and in which the following steps are carried out:
providing a common guide arrangement, which common guide arrangement defines a common first axis for each of the manipulators in the direction of its longitudinal extension, and each manipulator is autonomously displaceable along the common guide arrangement in the direction of the first axis,
providing the first manipulator and at least the second manipulator, each of the manipulators comprising
   a base frame,
   a first manipulator arm, wherein each of the first manipulator arms is pivotable about a second axis on the respective base frame,
   a second manipulator arm, wherein each of the second manipulator arms is pivotable about a third axis on the respective first manipulator arm on a side facing away from the base frame,
   a third manipulator arm, wherein each of the third manipulator arms is pivotable about a fourth axis on the respective second manipulator arm on a side facing away from the base frame,
   wherein the second axes, the third axes, and also the fourth axes are each exclusively in parallel orientation with respect to the first axis,
   a holding arrangement, which holding arrangement is arranged or formed on the respective third manipulator arm, and each of the holding arrangements is rotatable about a fifth axis, wherein each of the fifth axes is in a perpendicular orientation with respect to the respective fourth axis,
   wherein each of the third manipulator arms is arranged on the second manipulator arm on the side facing away from the first manipulator arm,
   wherein a sheet metal or a workpiece is grasped or gripped on its first side with the holding arrangement of the first manipulator, and
wherein the manipulators are arranged in succession in the direction of the first axis at or on the common guide arrangement and in a relative position to one another, in which the third manipulator arm of the first manipulator is arranged on that side of the second manipulator arm which faces the second manipulator, and the third manipulator arm of the second manipulator is arranged on that side of the second manipulator arm which faces the first manipulator, wherein it is further provided
that the manipulators are arranged so as to immediately adjoin one another for the transfer process, and in doing so, at least one of the manipulators is moved in the direction towards the other manipulator and moreover, in doing so, the third manipulator arms (26, 26′) are oriented to be opposite one another and their fifth axes are oriented, in each case, to project towards one another,
that, for the transfer process, the first and the second manipulator arm of the first manipulator are arranged on a first side with respect to a vertical central plane of the guide arrangement, which central plane is oriented so as to extend in the direction of the first axis, and the first and second manipulator arm of the second manipulator are arranged on a second side of the central plane of the guide arrangement opposite the first side, wherein the vertical central plane extends in a perpendicular direction with respect to a horizontal plane, and
the same sheet metal or workpiece is grasped or gripped with the holding arrangement of the second manipulator on its second side opposite the first side and the sheet metal or the workpiece is released or let go from the holding arrangement of the first manipulator.

In these method steps, it is advantageous that thereby, due to the mirror-symmetric arrangement of the individual manipulator arms of the first manipulator with respect to the second manipulator, it is made possible to arrange the manipulators, for the direct transfer between their holding arrangements, so far next to one another in their adjustment direction that their holding arrangements are arranged so as to be opposite one another and project towards one another. Thereby, the direct transfer of workpieces between the holding arrangements of the manipulators is still possible in manipulators of such simple design, in which the pivot axes of the individual manipulator arms are in a parallel orientation with respect to the axis defined by the guide arrangement, even without the intermediate step of intermediate storing. Thus, sufficient spatial conditions are created and hence, collisions between the individual manipulators and their manipulator arms during the transfer process are prevented. In manipulators, in which the first manipulator arm directly facing the base housing is additionally rotatable about a vertical rotation axis, the direct transfer could be realized by turning the holding arrangements towards one another and/or making them face one another, wherein this additional rotation movement is not provided in the manipulators according to the invention with the pivot axes of the manipulator arms always being oriented in a parallel direction with respect to the adjustment axis of the guide arrangement.

If, for the transfer process, the first and the second manipulator arm of the first manipulator are arranged on a first side with respect to a vertical central plane of the guide arrangement, which central plane is oriented so as to extend in the direction of the first axis, and the first and second manipulator arm of the second manipulator are arranged on a second side of the central plane of the guide arrangement opposite the first side, a position of the individual manipulator arms of the first and second manipulator relative to one another is achieved in the shortest possible way thereby. Hence, the respective manipulator arms of the first manipulator arm and of the second manipulator are located on each side of the central plane, whereby an even simpler opposing arrangement of the holding arrangements can be achieved.

Moreover, an approach, in which the second manipulator arm of the first manipulator is arranged on that side of the first manipulator arm which faces the second manipulator, is advantageous. Thereby, unnecessary collisions between the base frames of the manipulators can be prevented.

A further advantageous approach is characterized in that the second manipulator arm of the second manipulator is arranged on that side of the first manipulator arm which faces the first manipulator. Thereby, an additional distancing of the two base frames of the manipulators in the course of the transfer process can be achieved.

A method variant in which in each case the fifth axes of the third manipulator arms are arranged in a parallel orientation with respect to one another for the transfer process is also advantageous. By means of the parallel orientation of the transfer devices, a safe transfer process between the two holding arrangements can be achieved.

A different approach is characterized in that in each case the fifth axes of the third manipulator arms are arranged in an aligning orientation with respect to one another for the transfer process. Due to the aligning orientation of the fifth axes of the transfer arrangements facing one another, a safe holding and grasping can thus also be enabled also in the accepting holding arrangement.

A further advantageous approach is characterized in that the first axis of the guide arrangement is in a parallel orientation with respect to a bending line defined by a bending machine of the bending installation. This allows always maintaining and equal distance of the workpiece and/or sheet metal to be transported with respect to the bending line without an additional transverse adjustment relative to the first axis.

The object of the invention, however, is also independently achieved by a manipulation system for a bending installation comprising at least one bending machine. The manipulation system serves to directly transfer at least one sheet metal to be bent, or one workpiece formed from a sheet metal, from a first manipulator to at least one second manipulator. The manipulation system comprises
a common guide arrangement, which common guide arrangement defines a common first axis for each of the manipulators in the direction of its longitudinal extension, and each manipulator of the manipulation system is autonomously displaceable along the common guide arrangement in the direction of the first axis,
the first manipulator and the at least one second manipulator each comprise
   a base frame,
   a first manipulator arm, wherein each of the first manipulator arms is pivotable about a second axis on the respective base frame,
   a second manipulator arm, wherein each of the second manipulator arms is pivotable about a third axis on the respective first manipulator arm on a side facing away from the base frame,
   a third manipulator arm, wherein each of the third manipulator arms is pivotable about a fourth axis on the respective second manipulator arm on a side facing away from the base frame,
   wherein the second axes, the third axes, and also the fourth axes of each manipulator are each exclusively in parallel orientation with respect to the first axis,
   a holding arrangement, which holding arrangement is arranged or formed on the respective third manipulator arm, and each of the holding arrangements is rotatable about a fifth axis, wherein each of the fifth axes is in a perpendicular orientation with respect to the respective fourth axis, wherein
   each of the third manipulator arms is arranged on the second manipulator arm on the side facing away from the first manipulator arm, and wherein
the first manipulator and the at least one second manipulator are arranged in succession at or on the common guide arrangement in the direction of the first axis
wherein the third manipulator arm of the first manipulator is arranged on that side of the second manipulator arm which faces the second manipulator, and
wherein the third manipulator arm of the second manipulator is arranged on that side of the second manipulator arm which faces the first manipulator, wherein it is further provided
that the manipulators are arranged so as to directly adjoin one another for the transfer process, and in doing so, the third manipulator arms are oriented to be opposite one another and their fifth axes (29, 29′) are oriented, in each case, to project towards one another, and
that for the transfer process, the first and the second manipulator arm of the first manipulator are arranged on a first side with respect to a vertical central plane of the guide arrangement, which central plane is oriented so as to extend in the direction of the first axis, and the first and second manipulator arm of the second manipulator are arranged on a second side of the central plane of the guide arrangement opposite the first side, wherein the vertical central plane extends in a perpendicular direction with respect to a horizontal plane.

The advantage achieved thereby is that thus, due to the mirror-symmetric arrangement of the individual manipulator arms of the first manipulator with respect to the second manipulator, it is made possible to arrange the manipulators, for the direct transfer between their holding arrangements, so far next to one another in their adjustment direction that their holding arrangements are arranged so as to be opposite one another and project towards one another. Thereby, the direct transfer of workpieces between the holding arrangements of the manipulators is still possible in manipulators of such simple design, in which the pivot axes of the individual manipulator arms are in a parallel orientation with respect to the axis defined by the guide arrangement, even without the intermediate step of intermediate storing. Thus, sufficient spatial conditions are created and hence, collisions between the individual manipulators and their manipulator arms during the transfer process are prevented. In manipulators, in which the first manipulator arm directly facing the base housing is additionally rotatable about a vertical rotation axis, the direct transfer could be realized by turning the holding arrangements towards one another and/or making them face one another, wherein this additional rotation movement is not provided in the manipulators according to the invention with the pivot axes of the manipulator arms always being oriented in a parallel direction with respect to the adjustment axis of the guide arrangement.

If, for the transfer process, the first and the second manipulator arm of the first manipulator are arranged on a first side with respect to a vertical central plane of the guide arrangement, which central plane is oriented so as to extend in the direction of the first axis, and the first and second manipulator arm of the second manipulator are arranged on a second side of the central plane of the guide arrangement opposite the first side, a position of the individual manipulator arms of the first and second manipulator relative to one another is achieved in the shortest possible way thereby.

Moreover, it may be advantageous if the second manipulator arm of the first manipulator is arranged on that side of the first manipulator arm which faces the second manipulator. Thereby, unnecessary collisions between the base frames of the manipulators can be prevented.

A different embodiment is characterized in that the second manipulator arm of the second manipulator is arranged on that side of the first manipulator arm which faces the first manipulator. Thereby, an additional distancing of the two base frames of the manipulators in the course of the transfer process can be achieved.

A further possible embodiment comprises the features that the fifth axis of the first manipulator is arranged to extend in a first perpendicular plane with respect to the first axis, and the first perpendicular plane is arranged so as to be spaced apart from the base frame of the first manipulator by a first distance in the direction of the first axis as well as in the direction towards the second manipulator. This allows creating sufficient space between the fifth axis of the holding arrangements and the edge boundary of the base frame. Thus, a spacing and/or distancing of the fifth axis from the circumferential edge region of the base frame can be achieved in the region of the second manipulator, as well.

A further embodiment provides that the fifth axis of the second manipulator is arranged to extend in a second perpendicular plane with respect to the first axis, and the second perpendicular plane is arranged so as to be spaced apart from the base frame of the second manipulator by a second distance in the direction of the first axis as well as in the direction towards the first manipulator. Thus, the two manipulators can be adjusted towards one another in the region of their holding arrangements without colliding, and the holding arrangements can still be positioned opposite one another for the transfer process.

A different embodiment is characterized in that a sum of the first distance plus the second distance is equivalent at least to a greatest dimension of one of the third manipulator arms in the direction of the first axis. Due to this choice of dimension, a safe and collision-free opposite arrangement of the two manipulator arms can be achieved.

However, the object of the invention is also independently achieved by a bending installation comprising at least one bending machine and a manipulation system designed according to the invention for directly transferring at least one sheet metal to be bent or one workpiece formed from a sheet metal, from a first manipulation system to at least one second manipulator.

The advantage achieved thereby is that thus, a bending installation is created in which a direct transfer of workpieces between the manipulators without an additional step of intermediate storing is made possible by means of the manipulation system. Hence, the productive bending time of the bending machine is increased as additional intermediate storing operations are no longer necessary.

For the purpose of better understanding of the invention, it will be elucidated in more detail by means of the figures below.

These show in a respectively very simplified schematic representation:

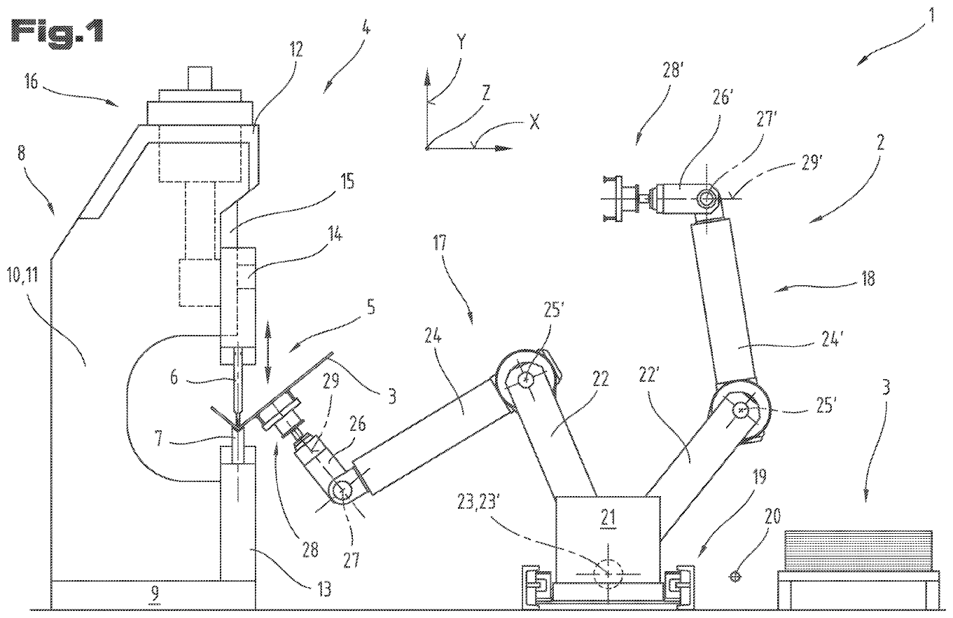

FIG. 1 a bending installation with a manipulation system for the direct transfer of a workpiece or sheet metal from a first manipulation system to a second manipulator, in a side view;

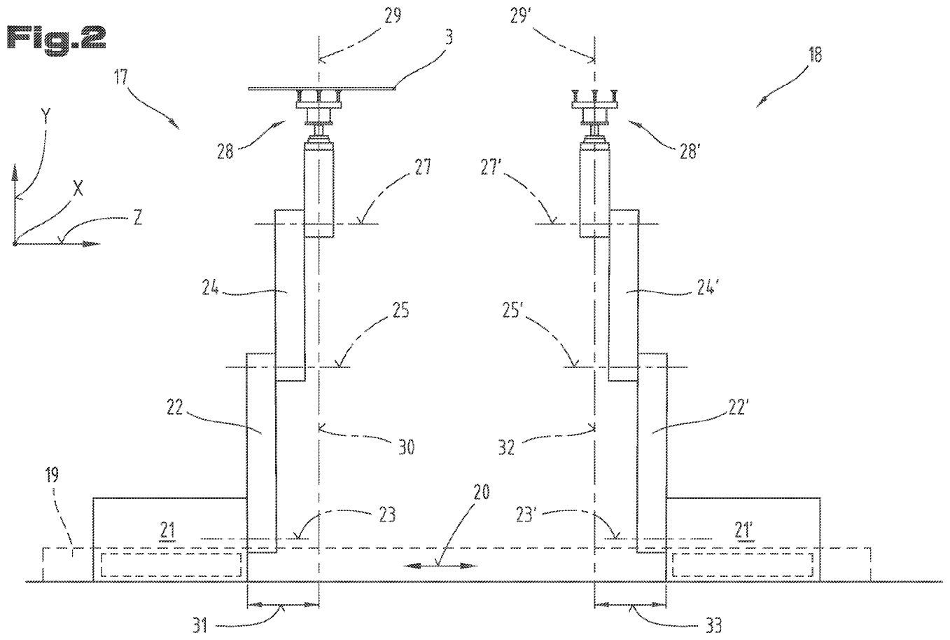

FIG. 2 a view of the manipulators of the manipulation system according to FIG. 1, in a position spaced apart from one another in the direction of the first axis;

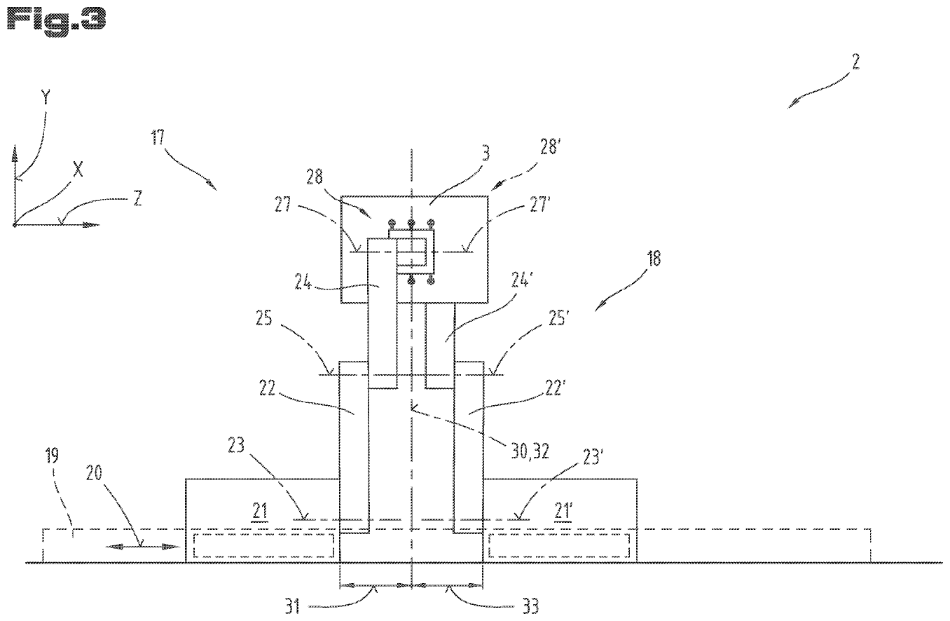

FIG. 3 a view of the manipulators of the manipulation system in their transfer position relative to one another;

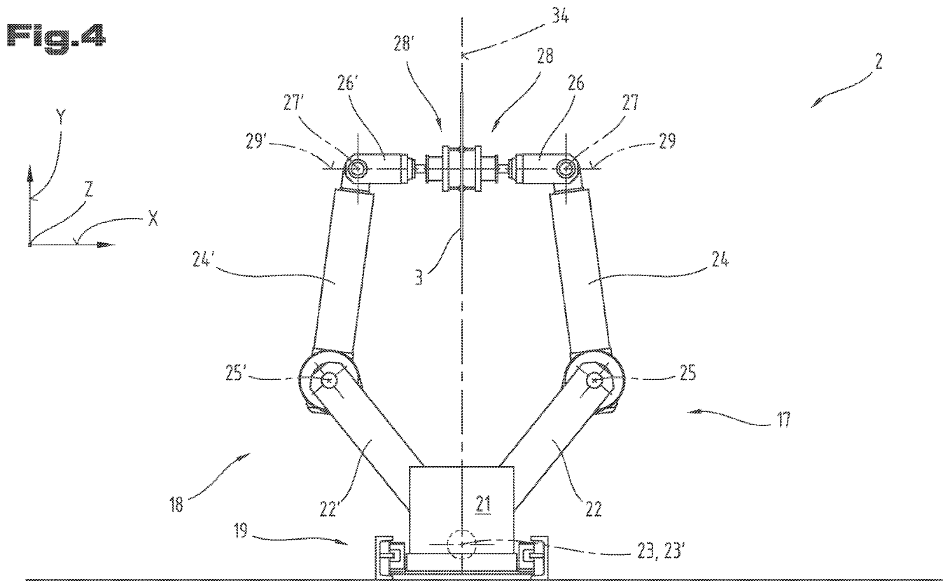

FIG. 4 the manipulators of the manipulation system in their transfer position relative to one another, in a side view.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The term “in particular” shall henceforth be understood to mean that it may refer to a possible more specific formation or more detailed specification of an object or a process step, but need not necessarily depict a mandatory, preferred embodiment of same or a mandatory practice.

FIGS. 1 to 4 show a bending installation 1 with a system 2 shown in a simplified view. In the present case, the bending installation 1 is designed particularly for air bending workpieces 3 to be produced from sheet metal by means of die bending, wherein it may also be referred to as production installation. Usually, a metallic material, which may be referred to as flats/panel in its undeformed state, is used as a source material. Some installation components of the bending installation 1 are not shown at all or only in a stylized manner in FIG. 1 to provide a better overview.

The bending installation 1 used for bending in the present case comprises at least a bending machine 4, in the present exemplary embodiment a bending press, in particular a press brake or die bending press, for manufacturing the workpieces 3 or parts between at least one bending tool 5 adjustable relative to one another. For the sake of simplicity, only one bending machine 4 was shown, wherein multiple ones may also be provided.

Independently thereof, however, it would also be possible to design the bending machine 4 as a so-called swivel bending machine or swing bending machine. In this case, the bending installation 1 may also be referred to as swivel bending installation or swing bending installation. In this regard, the bending machine 4 comprises a press, which is, inter alia, designed to clampingly hold the workpieces 3 or parts to be manufactured from the sheet metal between a clamping tool adjustable relative to one another. The clamping tool then comprises at least a lower clamping jaw and an upper clamping jaw cooperating therewith. The lower clamping jaw can also be referred to as lower cheek or counterhold and the upper clamping jaw can also be referred to as upper cheek or holding-down tool. The lower clamping jaw can also be designed as a continuous separate punch. For performing the bending operation, the bending machine 4 of the bending installation 1 also comprises a bending unit, which may also be referred to as a bevel unit or forming unit. This embodiment option of the bending machine 4 was only described but not shown in more detail. The type and design of the bending machine 4 is not essentially significant in the course of the method described below. The main focus is rather on the design of the manipulation system 2.

In the present exemplary embodiment, the bending tool 5 of the bending machine 4 shown here and designed as a bending press comprises at least one bending punch 6, however, most commonly multiple bending punches 6, and at least one bending die 7, however, most commonly multiple bending dies 7 cooperating therewith. At this, the at least one bending punch 6 is arranged on the bending machine 4 above the workpiece 3 to be manufactured and is held, in particular clamped, there correspondingly. The at least one bending die 7 is also held, in particular held clamped, on the bending machine 4.

In a coordinate system for such bending machines 4, the direction generally referred to as the “X”-direction is that which extends in a horizontal plane and in a perpendicular orientation with respect to the longitudinal extension of the bending tool 5, in particular its bending punch 6 and bending die 7. Thus, this is the direction which corresponds to the feed direction or the removal direction. The “Y”-direction is understood to be the vertical direction which thus extends in the height direction of the bending tool 5, and further in the perpendicular direction with respect to the horizontal plane. Lastly, the “z” direction is understood as the direction which extends in the longitudinal direction and/or the longitudinal extension of the bending tool 5, in particular its bending punch 6 and bending die 7. Hence, the longitudinal extension of the bending edge defined by the bending tool 5 is also oriented extending in the “z” direction.

The bending machine 4 comprises a machine frame 8, which has, for example, a base plate 9 and side walls 10, 11 rising up vertically therefrom and being oriented to be spaced apart from one another in the transverse direction and parallel to one another. These are preferably connected to one another by a massive cross connection 12 for example formed from a sheet metal preform on their end regions distanced from the base plate 9. The side walls 10, 11 may be designed approximately C-shaped for the creation of a clearance for the forming of the workpiece 3. The bending tool 5 is arranged and also held on press beams 13, 14. Most commonly, the lower press beam 13 is arranged to be stationary and may also be referred to as press table. The in this case upper press beam 14 is mounted to be guided in linear guides 15 and is adjustable relative to the lower press beam 13 for carrying out the bending operation. For this purpose, the driving arrangement 16 is provided. To provide a better overview, the more detailed description and representation of a bending machine control unit, an input terminal, and the energy supply was dispensed with. Further details required for the operation of such a bending machine 4, such as feed devices or the like, are also not addressed in the present description so as to avoid an unnecessary length of the description.

The manipulation system 2 comprises a first manipulator 17, at least one second manipulator 18, and a guide arrangement 19, on or at which the manipulators 17, 18 are guided so as to be adjustable along the same. The adjustment movement may take place autonomously, wherein a transmission of drive energy and/or travel and/or adjustment commands from the guide arrangement 19 to the manipulators 17, 18 is also possible. The guide arrangement 19 may comprise, e.g. guide rails, guide rods or the like, which are preferably oriented in a straight extension. The guide arrangement 19 defines a first axis 20 in the direction of its longitudinal extension. Preferably, the guide arrangement 19, and thus also the first axis 20 is parallel with respect to a bending line or bending edge defined by the bending tool 5 or the clamping tool and is thus also oriented so as to extend in parallel with respect to the “Z”-axis of the coordinate system.

In the following, the most essential components of the manipulators 17, 18 are described, wherein their components are generally designed similarly but their arrangement on the manipulators 17, 18 may be different. The components of the first manipulator 17 are designated without an inverted comma and/or without “′” and the components of the second manipulator 18 are designated with an inverted comma and/or with “′”.

Each of the manipulators 17, 18 comprises a base frame 21, 21′ which is guided so as to be adjustable on the guide arrangement 19, e.g. by means of wheels and/or separate guide elements. A more detailed representation and description of driving means was dispensed with as these are sufficiently known and may be freely selected according to the known prior art.

On each base frame 21, 21′, a first manipulator arm 22, 22′ is mounted thereon so as to be pivotable about a second axis 23, 23′. On each end region of the first manipulator arm 22, 22′ facing away from the base frame 21, 21′, a second manipulator arm 24, 24′ is mounted so as to be pivotable about a third axis 25, 25′. Moreover, a third manipulator arm 26,26′ is provided in each case, wherein each of the third manipulator arms 26, 26′ is pivotable about a fourth axis 27, 27′ on the respective second manipulator arm 24, 24′ on a side facing away from the base frame 21, 21′. In this regard, the second axes 23, 23′, the third axes 25, 25′, and also the fourth axes 27, 27′ each have an exclusively parallel orientation with respect to the first axis 20. Hence, the previously mentioned axes are oriented in parallel with respect to the bending line of the bending machine4.

The first manipulator arms 22, 22′ may be arranged on the respective base frame 21, 21′ either centrally thereon or also next to it, as it is shown in the present exemplary embodiment.

On each of the third manipulator arms 26, 26′, moreover, one holding arrangement 28, 28′ is arranged and/or provided. The holding arrangement 28, 28′ may be designed, for example as gripping pliers, a vacuum suction device, a holding magnet, or the like. Each of the holding arrangements 28, 28′ is mounted on the respective third manipulator arm 26, 26′ so as to be rotatable about a fifth axis 29, 29′. Each of the fifth axes 29, 29′ has a perpendicular orientation with respect to the respective fourth axis 27, 27′ and is thus oriented orthogonally thereto. Due to this possibility to rotate and/or pivot, the sheet metal or workpiece 3 held on the holding arrangement 28, 28′ can be rotated about its own axis, for example.

Moreover, it is provided for each of the manipulators 17, 18 that each of the third manipulator arms 26, 26′ is arranged, in each case, on the second manipulator arm 24, 24′ on the side facing away from the first manipulator arm 22, 22′.

As can be seen better in FIG. 2, when viewed in the direction of the first axis 20, the manipulators 17, 18 are arranged in succession at or on the common guide arrangement 19 and are movable relative thereto along the same. Moreover, a mirror-imaged arrangement of the individual manipulator arms relative to one another takes place, wherein this takes place with respect to a fictitious perpendicular plane between the two manipulators 17, 18 relative to the first axis 20. Thus, the third manipulator arm 26 of the first manipulator 17 is arranged on that side of the second manipulator arm24 which faces the second manipulator 18. However, the same applies to the third manipulator arm 26′ of the second manipulator 18. The third manipulator arm 26′ of the second manipulator 18 is thus arranged on that side of the second manipulator arm 24′ which faces the first manipulator 17.

The second manipulator arm 24 of the first manipulator 17 is arranged on that side of its first manipulator arm 22 which faces the second manipulator 18. The second manipulator arm 24′ of the second manipulator 18 is also arranged on that side of its first manipulator arm 22′ which faces the first manipulator 17. Thus, each of the third manipulator arms 26, 26′ is also not located on the same side as the first manipulator arms 22, 22′. The arrangement is always made in the direction towards the respective opposite manipulator 18 and/or 17.

It is also shown that the fifth axis 29 of the first manipulator 17 is arranged so as to extend in a first perpendicular plane 30 with respect to the first axis 20. Moreover, it is provided that the first perpendicular plane 30 is arranged so as to be spaced apart from the base frame 21 of the first manipulator 17 by a first distance 31 in the direction of the first axis 20 and in the direction towards the second manipulator 18.

The fifth axis 29 of the first manipulator 18 is arranged so as to extend in a second perpendicular plane 32 with respect to the first axis 20. Moreover, the second perpendicular plane 32 is arranged so as to be spaced apart from the base frame 21′ of the second manipulator 18 by a second distance 33 in the direction of the first axis 20 and in the direction towards the first manipulator 17.

In order to enable an opposite arrangement of the two holding arrangements 28, 28′ for the transfer process, at least one of the manipulators 17, 18 is to be moved in the direction towards the other one of the manipulators 18, 17. Due to the position of the third manipulator arms 26, 26′ in each case being on the outside with respect to the base frame 21, 21′ and opposite the manipulator 17, 18, the manipulators 17, 18 can be arranged directly adjoining one another.

A sum of the first distance 31 plus the second distance 33 is equivalent to at least a greatest dimension of one of the third manipulator arms 26, 26′ in the direction of the first axis 20.

The position of the manipulators 17, 18 and their manipulator arms before and during the transfer process can be seen best in FIGS. 2 to 4. For example, if a workpiece 3 or sheet metal is grasped by the holding arrangement 28 of the first manipulator 17 and if it is meant to be transferred to the holding arrangement 28′ of the second manipulator 18 directly and without intermediate storing, the third manipulator arms 26, 26′ are to be oriented so as to be opposite and to project towards one another. Then, the same workpiece 3 or sheet metal can also be grasped by the holding arrangement 28′ of the second manipulator 18. The grasping and/or holding by the holding arrangement 28 of the first manipulator 17 most commonly takes place at a first side and the grasping and/or holding by the holding arrangement 28′ of the second manipulator 18 takes place at the opposite second side. If the workpiece 3 or sheet metal is held by the holding arrangement 28′ of the second manipulator 18, as well, the workpiece 3 or sheet metal can be released from the holding arrangement 28 of the first manipulator 17. Thus, the direct transfer process is completed. A transfer from the holding arrangement 28′ of the second manipulator 18 to the holding arrangement 28 of the first manipulator 17 takes place in the same manner

Preferably, it is possible to arrange, in each case, the fifth axes 29, 29′ of the third manipulator arms 26, 26′ in a parallel orientation relative to one another for the transfer process. It may further be advantageous if, for the transfer process, in each case the fifth axes 29, 29′ of the third manipulator arms 26, 26′ are arranged in an aligning orientation with respect to one another.

For the transfer process, the first manipulator arm 22 and the second manipulator arm 24 of the first manipulator 17 may be arranged on a first side with respect to a vertical central plane 34 of the guide arrangement 19 that is oriented to extend in the direction of the first axis 20. The first manipulator arm 22′ and the second manipulator arm 24′ of the second manipulator 18, however, may be arranged on a second side of the central plane 34 of the guide arrangement 19 opposite the first side.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Bending installation |
| 2 | Manipulation system |
| 3 | Workpiece |
| 4 | Bending machine |
| 5 | Bending tool |
| 6 | Bending punch |
| 7 | Bending die |
| 8 | Machine frame |
| 9 | Base plate |
| 10 | Side wall |
| 11 | Side wall |
| 12 | Cross connection |
| 13 | Press beam |
| 14 | Press beam |
| 15 | Linear guide |
| 16 | Driving arrangement |
| 17 | First manipulator |
| 18 | Second manipulator |
| 19 | Guide assembly |
| 20 | First axis |
| 21 | Base frame |
| 22 | First manipulator arm |
| 23 | Second axis |
| 24 | Second manipulator arm |
| 25 | Third axis |
| 26 | Third manipulator arm |
| 27 | Fourth axis |
| 28 | Holding arrangement |
| 29 | Fifth axis |
| 30 | First perpendicular plane |
| 31 | First distance |
| 32 | Second perpendicular plane |
| 33 | Second distance |
| 34 | Central plane |

1-14. (canceled)

15. A method for directly transferring at least one sheet metal to be bent or one workpiece (3) formed from the sheet metal from a first manipulator (17) to at least one second manipulator (18) by means of a manipulation system (2) in a bending installation (1) having at least one bending machine (4), in which the following steps are carried out:
providing a common guide arrangement (19), which common guide arrangement (19) defines a common first axis (20) for each of the manipulators (17) in the direction of its longitudinal extension, and each manipulator (17, 18) is autonomously displaceable along the common guide arrangement (19) in the direction of the first axis (20),
providing the first manipulator (17) and at least the second manipulator (18), each of the manipulators (17, 18) comprising
a base frame (21, 21′),
a first manipulator arm (22, 22), wherein each of the first manipulator arms (22, 22′) is pivotable about a second axis (23, 23′) on the respective base frame (21, 21′),
a second manipulator arm (24, 24′), wherein each of the second manipulator arms (24, 24′) is pivotable about a third axis (25, 25′) on the respective first manipulator arm (22, 22′) on a side facing away from the base frame (21),
a third manipulator arm (26, 26′), wherein each of the third manipulator arms (26, 26′) is pivotable about a fourth axis (27, 27′) on the respective second manipulator arm (24, 24′) on a side facing away from the base frame (21, 21′),
wherein the second axes (23, 23), the third axes (25, 25′), and also the fourth axes (27, 27′) are each exclusively in parallel orientation with respect to the first axis (20),
a holding arrangement (28, 28′), which holding arrangement (28, 28′) is arranged or formed on the respective third manipulator arm (26, 26′), and each of the holding arrangements (28, 28′) is rotatable about a fifth axis (29, 29′), wherein each of the fifth axes (29, 29′) is in a perpendicular orientation with respect to the respective fourth axis (27, 27),
wherein each of the third manipulator arms (26, 26′) is arranged on the second manipulator arm (24, 24′) on the side facing away from the first manipulator arm (22, 22),
wherein a sheet metal or a workpiece (3) is grasped or gripped with the holding arrangement (28) of the first manipulator (17) on its first side, and
wherein the manipulators (17, 18) are arranged in succession in the direction of the first axis (20) at or on the common guide arrangement (19) and in a relative position to one another, in which the third manipulator arm (26) of the first manipulator (17) is arranged on that side of the second manipulator arm (24) which faces the second manipulator (18), and the third manipulator arm (26′) of the second manipulator (18) is arranged on that side of the second manipulator arm (24′) which faces the first manipulator (17),
wherein
the manipulators (17, 18) are arranged so as to directly adjoin one another for the transfer process, and in doing so, at least one of the manipulators (17, 18) is moved in the direction towards the other manipulator (18, 17) and moreover, in doing so, the third manipulator arms (26, 26′) are oriented to be opposite one another and their fifth axes (29, 29′) are oriented, in each case, to project towards one another,
for the transfer process, the first and the second manipulator arm (22; 24) of the first manipulator (7) are arranged on a first side with respect to a vertical central plane (34) of the guide arrangement (19), which central plane (34) is oriented so as to extend in the direction of the first axis (20), and the first and second manipulator arm (22′; 24′) of the second manipulator (18) are arranged on a second side of the central plane (34) of the guide arrangement (19) opposite the first side, wherein the vertical central plane (34) extends in a perpendicular direction with respect to a horizontal plane, and
the same sheet metal or workpiece (3) is grasped or gripped with the holding arrangement (28′) of the second manipulator (18) on its second side opposite the first side, and the sheet metal or the workpiece (3) is released or let go from the holding arrangement (28) of the first manipulator (17).

16. The method according to claim 15, wherein the second manipulator arm (24) of the first manipulator (17) is arranged on that side of the first manipulator arm (22) which faces the second manipulator (18).

17. The method according to claim 15, wherein the second manipulator arm (24′) of the second manipulator (18) is arranged on that side of the first manipulator arm (22′) which faces the first manipulator (17).

18. The method according to claim 15, wherein, for the transfer process, in each case the fifth axes (29, 29′) of the third manipulator arms (26, 26′) are arranged in a parallel orientation relative to one another.

19. The method according to claim 15, wherein, for the transfer process, in each case the fifth axes (29, 29′) of the third manipulator arms (26, 26′) are arranged in an aligning orientation with respect to one another.

20. The method according to claim 15, wherein the first axis (20) of the guide arrangement (19) is in a parallel orientation with respect to a bending line defined by a bending machine (4) of the bending installation (1).

21. A manipulation system (2) for a bending installation (1) comprising at least one bending machine (4), for the direct transfer of at least one sheet metal to be bent or one workpiece (3) formed from the sheet metal from a first manipulator (17) to at least one second manipulator (18), the manipulation system (2) comprising
a common guide arrangement (19), which common guide arrangement (19) defines a common first axis (20) for each of the manipulators (17, 18) in the direction of its longitudinal extension, and each manipulator (17, 18) of the manipulation system (2) is autonomously displaceable along the common guide arrangement (19) in the direction of the first axis (20),
the first manipulator (17) and the at least one second manipulator (18) each comprise
a base frame (21, 21′),
a first manipulator arm (22, 22), wherein each of the first manipulator arms (22, 22′) is pivotable about a second axis (23, 23′) on the respective base frame (21, 21′),
a second manipulator arm (24, 24′), wherein each of the second manipulator arms (24, 24′) is pivotable about a third axis (25) on the respective first manipulator arm (22, 22′) on a side facing away from the base frame (21, 21′),
a third manipulator arm (26, 26′), wherein each of the third manipulator arms (26, 26′) is pivotable about a fourth axis (27, 27′) on the respective second manipulator arm (24, 24′) on a side facing away from the base frame (21, 21′),
wherein the second axes (23, 23), the third axes (25, 25′), and also the fourth axes (27, 27′) of each manipulator (17, 18) are each exclusively in parallel orientation with respect to the first axis (20),
a holding arrangement (28, 28′), which holding arrangement (28, 28′) is arranged or formed on the respective third manipulator arm (26, 26′), and each of the holding arrangements (28, 28′) is rotatable about a fifth axis (29, 29′), wherein each of the fifth axes (29, 29′) is in a perpendicular orientation with respect to the respective fourth axis (27, 27), wherein
each of the third manipulator arms (26, 26′) is arranged on the second manipulator arm (24, 24′) on the side facing away from the first manipulator arm (22, 22), and wherein
the first manipulator (17) and the at least one second manipulator (18) are arranged in succession at or on the common guide arrangement (19) in the direction of the first axis (20),
wherein the third manipulator arm (26) of the first manipulator (17) is arranged on that side of the second manipulator arm (24) which faces the second manipulator (18), and
wherein the third manipulator arm (26′) of the second manipulator (18) is arranged on that side of the second manipulator arm (24′) which faces the first manipulator (17), in particular for carrying out the direct transfer process according to claim 15, wherein
the manipulators (17, 18) are arranged so as to directly adjoin one another for the transfer process, and in doing so, the third manipulator arms (26, 26′) are oriented so as to be opposite one another and their fifth axes (29, 29′) are oriented, in each case, to project towards one another, and
for the transfer process, the first and the second manipulator arm (22; 24) of the first manipulator (17) are arranged on a first side with respect to a vertical central plane (34) of the guide arrangement (19), which central plane (34) is oriented so as to extend in the direction of the first axis (20), and the first and second manipulator arm (22′; 24′) of the second manipulator (18) are arranged on a second side of the central plane (34) of the guide arrangement (19) opposite the first side, wherein the vertical central plane (34) extends in a perpendicular direction with respect to a horizontal plane.

22. The manipulation system (2) according to claim 21, wherein the second manipulator arm (24) of the first manipulator (17) is arranged on that side of the first manipulator arm (22) which faces the second manipulator (18).

23. The manipulation system (2) according to claim 21, wherein the second manipulator arm (24′) of the second manipulator (18) is arranged on that side of the first manipulator arm (22′) which faces the first manipulator (17).

24. The manipulation system (2) according to claim 21, wherein the fifth axis (29) of the first manipulator (17) is arranged to extend in a first perpendicular plane (30) with respect to the first axis (20), and the first perpendicular plane (30) is arranged so as to be spaced apart from the base frame (21) of the first manipulator (17) by a first distance (31) in the direction of the first axis (20) as well as in the direction towards the second manipulator (18).

25. The manipulation system (2) according to claim 24, wherein the fifth axis (29′) of the second manipulator (18) is arranged to extend in a second perpendicular plane (32) with respect to the first axis (20), and the second perpendicular plane (32) is arranged so as to be spaced apart from the base frame (21′) of the second manipulator (18) by a second distance (33) in the direction of the first axis (20) as well as in the direction towards the first manipulator (17).

26. The manipulation system (2) according to claim 25, wherein a sum of the first distance (31) plus the second distance (33) is equivalent at least to a greatest dimension of one of the third manipulator arms (26, 26′) in the direction of the first axis (20).

27. A bending installation (1) comprising at least a bending machine (4) and a manipulation system (2) for directly transferring at least one sheet metal to be bent or one workpiece (3) formed from the sheet metal from a first manipulator (17) to at least one second manipulator (18), wherein the manipulation system (2) is designed according to claim 21.
